(19) United States
(12) Patent Application Publication
(10) Pub. No.: US 2009/0256746 A1
(43) Pub. Date: Oct. 15, 2009

(54) INTIMATING SYSTEM AND AN INTIMATING METHOD

(75) Inventor: Yi-Hung SHEN, TAIPEI CITY (TW)

Correspondence Address: Chih Feng Yeh;BRIAN M. MCINNIS, 12th Floor, Ruttonjee House, 11 Duddell Street, Hong Kong, HK

(73) Assignee: COMPAL ELECTRONICS, INC., TAIPEI CITY (TW)

(21) Appl. No.: 12/249,966

(22) Filed: Oct. 13, 2008

(30) Foreign Application Priority Data
Apr. 11, 2008 (TW) 97113272

(51) Int. Cl. G01S 5/14; G06F 7/00

(52) U.S. Cl. 342/357.13; 707/100; 707/104.1

(57) ABSTRACT

An intimating system is provided. The intimating system comprises a host and a plurality of portable editors. The host comprises a storing device to store a plurality of target data; a location device to provide a location data; a comparator to compare the location data and the plurality of target data and a sender to send a confirming signal while the location data matches the at least one target data. Each of the portable editors corresponds to a target data and comprises a receiver and an intimating device, wherein the receiver is to receive the confirming signal when the corresponding target data matches the location data and the intimating device is to generate an intimating signal according to the confirming signal.

### RELATED APPLICATIONS

This application claims priority to Taiwan Application Serial Number 97113272, filed Apr. 11, 2008, which is herein incorporated by reference.

### BACKGROUND

1. Field of Invention

The present invention relates to an intimating system. More particularly, the present invention relates to an intimating system and an intimating method.

2. Description of Related Art

Various kinds of mass transport systems, e.g. bus system, rail system and subway system, play an important role in our life. The passengers on the mass transport system may not be familiar to the lines and the stops of the transport system. Further, the passengers may take a rest during a long distance traveling on the mass transport system. If there is no intimating mechanism to remind the passenger the location of the mass transport, the passengers will easily miss the stops due to the above reasons.

The conventional intimating mechanism makes use of a broadcast system or a ticker system to remind the passengers with a voice and a text message respectively. However, as to the broadcast system, a voice message is easy to disturb the passengers taking rest on the transport. As to the ticker system, the passengers have to focus on the text message shown on the ticker system to avoid missing the message. Furthermore, the passengers taking rest on the transport may not notice the message on the ticker system and may miss the stops. Also, it may not easy to clearly read the message of the ticker system if the passengers stay too far away from the ticker system.

Accordingly, what is needed is an intimating system and an intimating method to remind the individual user the location of the mass transport without disturbing other people to overcome the above issues. The present invention addresses such a need.

### SUMMARY

An intimating system is provided. The intimating system comprises a host and a plurality of portable editors. The host comprises a storing device, a location device, a comparator and a sender. The storing device is to store a plurality of target data. The location device is to provide a location data. The comparator is to compare the location data and the plurality of target data; and the sender is to send a confirming signal while the location data matches the at least one target data. Each of the plurality of portable editor corresponds to a target data. Each of the portable editor comprises a receiver and an intimating device. The receiver is to receive the confirming signal when the corresponding target data matches the location data; and the intimating device is to generate an intimating signal according to the confirming signal.

Another object of the present invention is to provide an intimating system. The intimating system comprises a host and a portable editor. The host comprises a location device and a sender. The location device is to provide a location data. The sender is to send the location data. The portable editor comprises a storing device, an input device, a receiver, a comparator and an intimating device. The storing device is to store a plurality of target data. The input device is to select one of the plurality of target data as a default target data. The receiver is to receive the location data. The comparator is to compare the location data and the default target data; and the intimating device is to generate an intimating signal while the location data matches the default target data.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of an intimating system of the first embodiment of the present invention; and

FIG. 2 is a block diagram of an intimating system of the second embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

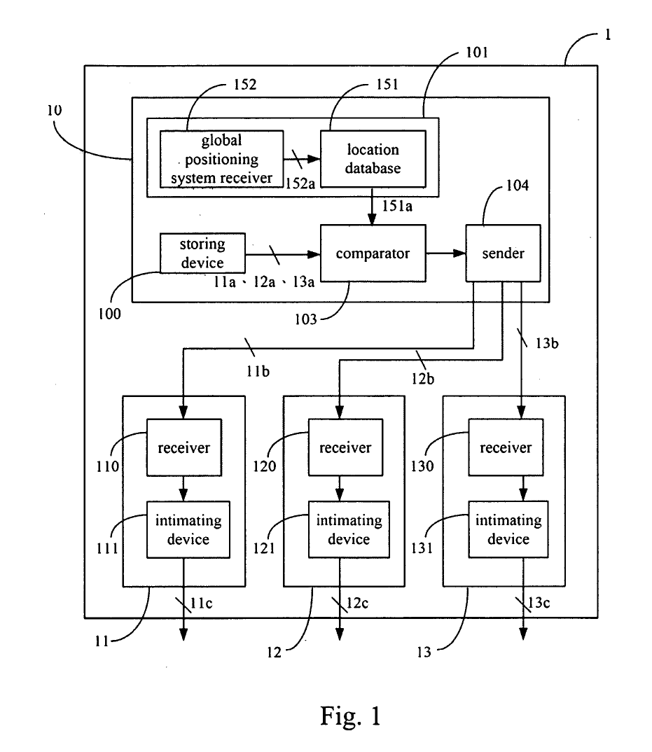

Please refer to FIG. 1, a block diagram of an intimating system 1 of the first embodiment of the present invention. In the present embodiment, the intimating system 1 comprises a host 10 and three portable editors 11, 12 and 13. The host 10 is placed in a mass transport (not shown) such as a bus, a train or a subway. Each of the portable editors 11, 12 and 13 is hold respectively by a passenger on the mass transport. The number of the portable editors in other embodiment may vary according to the number of the passengers having the portable editors. It's noticed that the portable editors can be placed in a portable device such as a cell phone or a PDA. Thus, the intimating signal can be sent to each individual user.

The host 10 comprises a storing device 100, a location device 101, a comparator 103 and a sender 104. The storing device 100 is to store a plurality of target data corresponding to the target data in the portable editors, wherein in the present embodiment, the target data 11a, 12a, 13a corresponding to the portable editors 11, 12 and 13. The target data 11a, 12a and 13a are sent from the portable editors 11, 12 and 13 to the storing device 100 of the host 10 through wireless data transmission when the passengers having the portable editors 11, 12 and 13 get on the mass transport. Substantially, the passengers owning the portable editors 11, 12 and 13 can edit the target data according to the destination of each passenger. Take a high speed rail system as example, if a train goes from Taipei to Kaohsiung and the targets of three passengers on the train are Hsin-Chu, Taichung and Kaohsiung respectively, then the data of Hsin-chu (11a), Taichung (12a) and Kaohsiung (13a) will be sent from the portable editors of the three passengers to the storing device of the host on the train. The location device 101 comprises a global positioning system (GPS) receiver 152 and a location database 151. The global positioning system receiver 152 is to receive a global positioning system data 152a to affirm the position of the mass transport according to the global positioning system (not shown). The location database 151 is a database of maps, a database of coordinates or a database of the combination of maps and coordinates. Through the use of the location database 151, the name of the place and/or the coordinates of the mass transport can be found after receiving the global positioning system data 152a to provide the location data 151a. The comparator 103 is to compare the location data 151a and the target data 11a, 12a and 13a. The sender 104 is to send a confirming signal while the location data 151a match the target data 11a, 12a, 13a. In the present embodiment, if the train arrives at Hsin-chu (11a), the location data 101a will become Hsin-chu as well, is and the confirming signal 11b will be sent. If the train arrives at Taichung (12a), the location data 101a will become Taichung as well, and the confirming signal 12b will be sent. Similarly, if he train arrives at Kaohsiung (13a), the location data 101a will become Kaohsiung as well, and the confirming signal 13b will be sent.

Each of the portable editor 11, 12 and 13 hold by the passengers comprises a receiver 110, 120, 130 and an intimating device 111, 121, 131. The receiver 110, 120 and 130 receives the confirming signal 11b, 12b and 13b when the target data 11a, 12a and 13a respectively matches the location data 151a. The intimating device 111, 121 and 131 further generate an intimating signal 11c, 12c and 13c according to the confirming signal 11b, 12b and 13b respectively.

In the present embodiment, the portable editor 11, 12 and 13 will receive the confirming signal 11b, 12b and 13b when the train arrives at Hsin-chu (11a), Taichung (12a) and Kaohsiung (13a) respectively and generate the intimating signal 11c, 12c and 13c. The intimating signal can be a text signal, a voice signal, a light signal or a combination of the above to remind the user that the train arrives at the location that matches the target data.

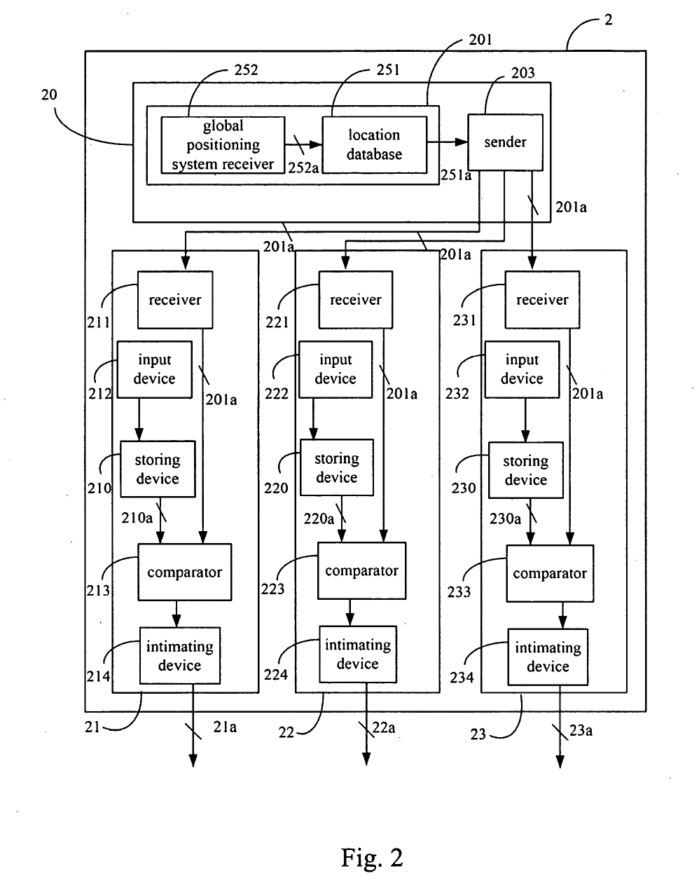

FIG. 2 is a block diagram of an intimating system 2 of the second embodiment of the present invention. In the present embodiment, the intimating system comprises a host 20 and three portable editors 21, 22 and 23. The host 20 is placed in the mass transport and the three portable editors 21, 22 and 23 are hold by the passengers, as described in the first embodiment. The host 20 comprises a location device 201 and a sender 203. The location device 201 comprises a global positioning system (GPS) receiver 252 and a location database 251. The global positioning system receiver 252 is to receive a global positioning system data 252a to affirm the position of the mass transport according to the global positioning system (not shown). The location database 251 is a database of maps, a database of coordinates or a database of the combination of maps and coordinates. Through the use of the location database 251, the name of the place and/or the coordinates of the mass transport can be found after receiving the global positioning system data 252a to provide the location data 251 a. The sender 203 is to send the location data 251a to each of the portable editor 21, 22 and 23.

Each of the portable editors 21, 22 and 23 comprises a storing device 210, 220, 230, an input device 211, 221, 231, a receiver 212, 222, 232, a comparator 213, 223, 233 and an intimating device 214, 224, 234. Each of the storing device 210, 220, 230 is to store a target data 210a, 220a and 230a respectively. The input device is to select one of the plurality of target data as a default target data. The receiver is to receive the location data. The comparator is to compare the location data and the default target data; and the intimating device is to generate an intimating signal while the location data matches the default target data. Take a high speed rail system as example, if a train goes from Taipei to Kaohsiung and the targets of three passengers on the train are Hsin-Chu, Taichung and Kaohsiung respectively, then the data of Hsin-chu (210a), Taichung (220a) and Kaohsiung (230a) are all stored in the storing device 210, 220 and 230 of the portable editors of the three passengers. The input device is to select one of the target data 210a. 220a, 230a as a default target data. For example, if the passenger having the portable editor 21 wants to go to Hsin-chu, he/she can select Hsin-chu as the default target data through the input device 211. In one embodiment, the input device is a plurality of selection buttons each corresponding to one of the plurality of target data. In another embodiment, the input device is a selection button to select one of the plurality of target data by continuously pressing the selection button. Yet in another embodiment, the input device is a touch screen to select one of the plurality of target data shown on the screen by touching the screen.

The receiver 212, 222, 232 are to receive the location data 201a that stands for the present location of the train. The comparator 213, 223, 233 compare the location data 251a and the target data 210a, 220a and 230a respectively. When the train arrives at Hsin-chu, the intimating device 214 will generate an intimating signal 214a since the location data 251a matches the target 210a. When the train arrives at Taichung, the intimating device 224 will generate an intimating signal 224a since the location data 251a matches the target 220a. Similarly, when the train arrives at Kaohsiung, the intimating device 234 will generate an intimating signal 234a since the location data 251a matches the target 230a. The intimating signal can be a text signal, a voice signal, a light signal or a combination of the above to remind the user that the train arrives at the location that matches the target data.

The intimating system of the present invention provides an intimating mechanism to remind the individual user the location of the mass transport without disturbing other people.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An intimating system comprising:
a host comprising:
a storing device to store a plurality of target data;
a location device to provide a location data;
a comparator to compare the location data and the plurality of target data; and
a sender to send a confirming signal while the location data matches the at least one target data;
a plurality of portable editors, wherein each of the portable editor corresponds to a target data, each of the portable editor comprises:
a receiver to receive the confirming signal when the corresponding target data matches the location data; and
an intimating device to generate an intimating signal according to the confirming signal.

2. The intimating system of claim 1, wherein the location device further comprising:
a global positioning system (GPS) receiver to receive a global positioning system data; and
a location database to generate the location data according to the global positioning system data.

3. The intimating system of claim 2, wherein the location database is a database of maps, a database of coordinates or a database of the combination of maps and coordinates.

4. The intimating system of claim 1, wherein the intimating signal is a text signal, a voice signal, a light signal or a combination of the above.

5. An intimating system comprising:
a host comprising:
a location device to provide a location data; and
a sender to send the location data; and
a portable editor comprising:
a storing device to store a plurality of target data;
an input device to select one of the plurality of target data as a default target data;
a receiver to receive the location data;
a comparator to compare the location data and the default target data; and
an intimating device to generate an intimating signal while the location data matches the default target data.

6. The intimating system of claim 5, wherein the input device is a plurality of selection buttons each corresponding to one of the plurality of target data.

7. The intimating system of claim 5, wherein the input device is a selection button to select one of the plurality of target data by continuously pressing the selection button.

8. The intimating system of claim 5, wherein the input device is a touch screen to select one of the plurality of target data shown on the screen by touching the screen.

9. The intimating system of claim 5, wherein the location device further comprises:
a global positioning system receiver to receive a global positioning system data; and
a location database to generate the location data according to the global positioning system data.

10. The intimating system of claim 9, wherein the location database is a database of maps, a database of coordinates or a database of the combination of maps and coordinates.

11. The intimating system of claim 5, wherein the intimating signal is a text signal, a voice signal, a light signal or a combination of the above.
